(19) United States
(12) Patent Application Publication
(10) Pub. No.: US 2013/0343314 A1
(43) Pub. Date: Dec. 26, 2013

(54) Channel Configuration

(71) Applicants: Esa Tapani Tiirola, Kempele (FI); Kari Pekka Pajukoski, Oulu (FI); Kari Juhani Hooli, Oulu (FI)

(72) Inventors: Esa Tapani Tiirola, Kempele (FI); Kari Pekka Pajukoski, Oulu (FI); Kari Juhani Hooli, Oulu (FI)

(73) Assignee: Nokia Siemens Networks Oy, Espoo (FI)

(21) Appl. No.: 13/983,104

(22) PCT Filed: Feb. 1, 2011
(86) PCT No.: PCT/EP2011/051364

§ 371 Date: Aug. 30, 2013

(51) Int. Cl. H04L 5/00

(52) U.S. Cl. CPC H04L 5/0048
USPC 370/329

(57) ABSTRACT

The invention relates to apparatuses, a method, computer program and computer-readable medium. The method includes: configuring physical layer numerology according to a cyclic prefix length; configuring at least one of physical layer procedures according to an extended cyclic prefix length; configuring an auxiliary reference signal block for at least one slot, and controlling the placement of at least one of: a reference signal block and the auxiliary reference signal block within a slot.

### FIELD

The invention relates to the field of cellular radio telecommunications and, particularly, to a method for physical channel configuration, to an apparatus, and to a computer program product.

### BACKGROUND

It has been identified that uplink demodulation reference signal density is not sufficient with higher long term evolution (LTE) advanced frequencies to meet uplink performance requirements given. Thus, for example, new uplink frame structure with denser demodulation reference signal for physical uplink shared channel (PUSCH) have been proposed in the development of future LTE beyond Release-10. Further, it has been under discussion that an alternative for demodulation reference signal evolution in LTE-Advanced is to preclude deployments of high-speed cells on higher carrier frequencies.

High Doppler results in multiple access interference between cells, for example, due to CDMA access used on physical uplink control channel (PUCCH). Thus, there is a need to avoid interference problems due to high Doppler, maintain multiplexing capacity and randomization properties of Release-8 and to achieve sufficient demodulation reference signal density.

### BRIEF DESCRIPTION

According to an aspect of the present invention, there is provided an apparatus as specified in claim 1.

According to another aspect of the present invention, there is provided a method as specified in claim 12. According to another aspect of the present invention, there is provided an apparatus as specified in claim 23. According to yet another aspect of the present invention, there is provided a computer program product embodied on a computer readable distribution medium as specified in claim 24.

Embodiments of the invention are defined in the dependent claims.

### LIST OF DRAWINGS

Embodiments of the present invention are described below, by way of example only, with reference to the accompanying drawings, in which

FIG. 1 illustrates an example of a system;

FIG. 2 is a flow chart;

FIG. 3 is an example of an embodiment;

FIG. 4 shows an example of an apparatus, and

FIG. 5 is an example of an embodiment.

### DESCRIPTION OF EMBODIMENTS

The following embodiments are exemplary. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may contain also features/structures that have not been specifically mentioned.

Embodiments are applicable to any user device, such as a user terminal, relay node, server, node, corresponding component, and/or to any communication system or any combination of different communication systems that support required functionalities. The communication system may be a wireless communication system or a communication system utilizing both fixed networks and wireless networks. The protocols used, the specifications of communication systems, apparatuses, such as servers and user terminals, especially in wireless communication, develop rapidly. Such development may require extra changes to an embodiment. Therefore, all words and expressions should be interpreted broadly and they are intended to illustrate, not to restrict, embodiments.

In the following, different embodiments will be described using, as an example of access architectures to which the embodiments may be applied, a radio access architecture based on long term evolution (LTE) advanced, LTE-A, that is based on orthogonal frequency multiplexed access (OFDMA) in a downlink and a single-carrier frequency-division multiple access (SC-FDMA) in an uplink, without restricting the embodiments to such an architecture, however.

Radio communication networks, such as the Long Term Evolution (LTE) or the LTE-Advanced (LTE-A) of the 3rd Generation Partnership Project (3GPP), are typically composed of at least one base station (also called a base transceiver station, a Node B, or an evolved Node B, for example), a user equipment (also called a user terminal and a mobile station, for example) and optional network elements that provide the interconnection towards the core network. The base station connects the UEs via a radio interface to the network.

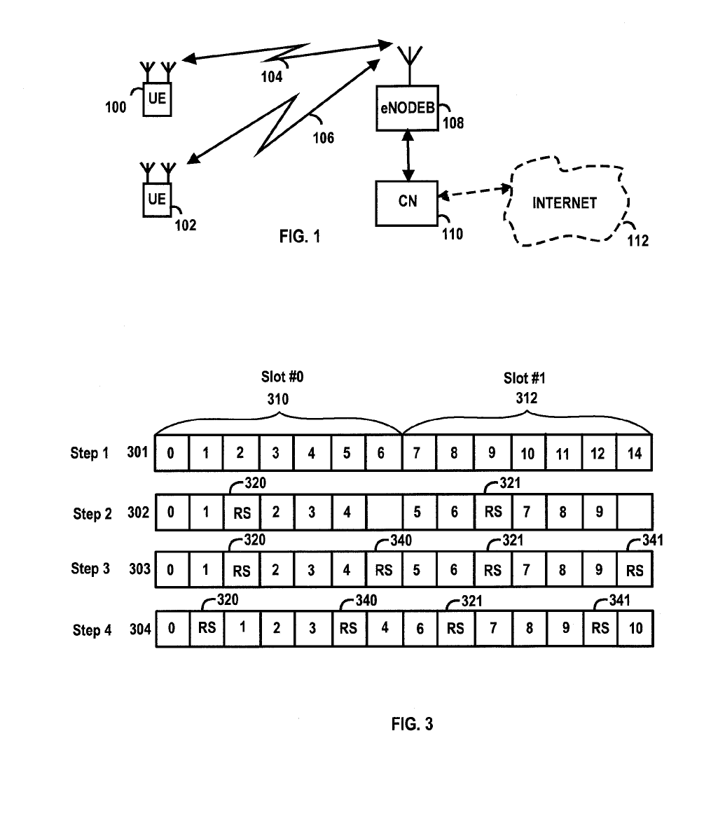

FIG. 1 is an example of a simplified system architecture only showing some elements and functional entities, all being logical units whose implementation may differ from what is shown. The connections shown in FIG. 1 are logical connections; the actual physical connections may be different. It is apparent to a person skilled in the art that the system typically comprises also other functions and structures than those shown in FIG. 1.

FIG. 1 shows a part of a radio access network of E-UTRA, LTE or LTE-advanced (LTE-A) or LTE/EPC (EPC=evolved packet core, EPC is enhancement of packet switched technology to cope with faster data rates and growth of Internet protocol traffic). E-UTRA is an air interface of Release 8 (UTRA=UMTS terrestrial radio access, UMTS=universal mobile telecommunications system). Some advantages obtainable by LTE (or E-UTRA) are a possibility to use plug and play devices, and Frequency Division Duplex (FDD) and Time Division Duplex (TDD) in the same platform. The embodiments are not, however, restricted to the systems given as an example but a person skilled in the art may apply the solution to other communication systems provided with the necessary properties. Some examples of other options for suitable systems are the universal mobile telecommunications system (UMTS) radio access network (UTRAN or E-UTRAN), long term evolution (LTE, the same as E-UTRA), wireless local area network (WLAN or WiFi), worldwide interoperability for microwave access (WiMAX), Bluetooth®, personal communications services (PCS), wideband code division multiple access (WCDMA), code division multiple access (CDMA), groupe spécial mobile or global system for mobile communications (GSM), enhanced data rates for GSM evolution (GSM EDGE or GERAN), systems using ultra-wideband (UWB) technology and different mesh networks. Embodiments are especially suitable for coexistence networks of two or more systems.

FIG. 1 shows user devices 100 and 102 configured to be in a wireless connection on one or more communication channels 104, 106 in a cell with an LTE (e)NodeB 108 providing the cell. The physical link from a user device to an LTE (e)NodeB is called uplink or reverse link and the physical link from the LTE NodeB to the user device is called downlink or forward link.

The NodeB, or advanced evolved node B (eNodeB, eNB) in LTE-advanced, is a computing device configured to control the radio resources of a communication system it is coupled to. The (e)NodeB may also be referred to a base station, an access point or any other type of interfacing device including a relay station capable of operating in a wireless environment. The (e)NodeB may also be a virtual node, if real-world processing is carried out in a distant network processing centre coupled to a physical cell, by fiber cables, for instance.

The (e)NodeB includes at least one transceiver, for instance. From the transceiver(s) of the (e)NodeB, a connection is provided to an antenna unit that establishes bidirectional radio links to user devices. The (e)NodeB is further coupled to a core network 110 (CN). Depending on the system, the counterpart on the CN side for the LTE may be a serving gateway (S-GW) (routing and forwarding user data packets), packet data network gateway (P-GW), for providing connectivity to user devices (UEs) to external packet data networks, or mobile management entity (MME), etc.

The communication systems are typically also able to communicate with other networks, such as a public switched telephone network or the Internet 112.

The user device illustrates one type of an apparatus to which resources on the air interface may be allocated and assigned, and thus any feature described herein with a user device may be implemented with a corresponding apparatus. The user device may also be called a subscriber unit, mobile station, remote terminal, access terminal, user terminal or user equipment (UE) just to mention but a few names or apparatuses.

The user device typically refers to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device.

It should be understood that, in FIG. 1, user devices are depicted to include 2 antennas only for the sake of clarity. The number of reception and/or transmission antennas may naturally vary according to a current implementation.

Further, although the apparatuses have been depicted as single entities, different units, processors and/or memory units (not all shown in FIG. 1) may be implemented.

It is obvious for a person skilled in the art that what is depicted is only an example of a part of a radio access systems and in practise, the system may comprise a plurality of (e)NodeBs, the user device may have an access to a plurality of radio cells and the system may comprise also other apparatuses, such as physical layer relay nodes or other network elements, etc. At least one of the NodeBs or eNodeBs may be a Home(e)nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometres, or smaller cells such as micro-, femto- or picocells.

For example, the (e)NodeB 108 of FIG. 1 may provide any kind of these cells. A cellular radio system may be implemented as a multilayer network including several kinds of cells. Typically, in multilayer networks, one (e)NodeB provides one kind of a cell or cells, and thus a plurality of (e)NodeBs are required to provide such a network structure.

The high Doppler issue discussed in RAN1 is well known. The discussion has been focused on the DM RS (Demodulation Reference Signal) structure of PUSCH (UL has been shown to be a limiting factor in high-Doppler scenario). Potential problems related to other channels such as PUCCH have not been raised in 3GPP. However, PUCCH carrying time-critical L1/L2 control information such as ACK/NACK (positive acknowledgement/negative acknowledgement) should have the highest priority when creating system support for high speed trains. Further, the high Doppler issue is potentially more harmful for PUCCH than for PUSCH because it results in multiple access interference between UEs due to CDMA access used on PUCCH.

Some of the problems related to high-Doppler PUCCH include: interference problems between high-speed UEs and low-speed UEs, interference problems between two high-speed UEs, maintaining multiplexing capacity/randomization properties of Release-8, achieving sufficient DM RS density.

Interference problems relate, for example, to PUCCH Format 1/1a/1b² (Scheduling request/1-bit ACK/NACK/2-bit ACK/NACK) utilizing block-level spreading. It is known that channel Doppler spread limits the orthogonality between block-wise spread sequences as radio channel changes during the spreading period. This results in intra-cell interference between UEs using the same/adjacent cyclic shift resources within one resource block, as illustrated in Table 1. Table 1 shows 1/1a/1b channelization within one resource block with Delta_shift=2 and a normal CP. A high-speed UE (#13) experiences strong interference from adjacent resources (#1, #6, #7). Low-speed UEs (#1, #6, #7) become interfered by the high-speed UE (#13).

TABLE 1
1/1a/1b channelization within one resource block,
Delta_shift = 2, normal CP.

| | Orthogonal cover code | | |
|---|---|---|---|
| Cyclic shift | 0 | 1 | 2 |
| 0 | 0 | | 12 |
| 1 | | 6 | |
| 2 | 1 | | 13 |
| 3 | | 7 | |
| 4 | 2 | | 14 |
| 5 | | 8 | |
| 6 | 3 | | 15 |
| 7 | | 9 | |
| 8 | 4 | | 16 |
| 9 | | 10 | |
| 10 | 5 | | 17 |
| 11 | | 11 | |

Relating to PUSCH scenarios, one proposal is to use time division multiplexing on demodulation reference signal and data within some of SC-FDMA (single-carrier frequency division multiple access) symbols instead of having a separate SC-FDMA symbol for data and demodulation reference signal. However, this proposal involves several drawbacks. Channel estimation at eNB side is considerably affected starting from the required DFT (Discrete Fourier Transform) sizes. Additionally, the proposal requires the specification of new demodulation reference signal sequences due to changes in the supported sequence lengths. Further, CP (Cyclic Prefix) induced overhead is increased when introducing four new CPs per subframe. Thus, overall system complexity is increased.

In LTE Release-8 PUCCH scenarios, channelization is used which in turn results in multiuser interference in the presence of high Doppler shift. Block level spreading principle, i.e. the way of placement of data (A/N) and reference signal (RS) blocks within a slot, used in LTE Release-8 has been made such a way that block-spreading for A/N part is more critical from Doppler point of view than block-spreading for RS part. Table 2 shows the orthogonal block spreading sequences or orthogonal cover codes (OCC) used for ACK/NACK part on PUCCH Format 1/1a/1b in case of normal CP (only two first sequences are used with extended CP length). It is known that under high Doppler conditions, OCC#0 has good cross-correlation properties against other cover codes. At the same time, there is an interference problem between OCC#1 and OCC#2 under high Doppler conditions. It is noted that OCC#0 and OCC#1 (as well as OCC#0 and OCC#2) are mutually orthogonal against each other not only over four symbols but also over two consecutive (1, 2 and 3, 4) symbols. This property improving the cross-correlation properties may be called “partial orthogonality”.

TABLE 2
Orthogonal sequences [w(0) . . .
w(N_{SF}^{PUCCH} − 1)] for N_{SF}^{PUCCH} = 4

| Sequence index | Orthogonal sequences |
|---|---|
| n_{oc} (n₅) | [w(0) . . . w(N_{SF}^{PUCCH} − 1)] |
| 0 | [+1 +1 +1 +1] |
| 1 | [+1 −1 +1 −1] |
| 2 | [+1 −1 −1 +1] |

Partial orthogonality properties may be taken into account in resource allocation such that in extreme conditions (e.g. UE speed of 360 km/h) only codes that are partially orthogonal against each other are taken into use.

This means that either OCC#1 or OCC#2 should not be used. The problem with, for example, Release-8 is however, that cyclic shift/orthogonal cover code remapping, which is always used on PUCCH destroys the partial orthogonality by randomizing the resources within the same PUCCH resource block. Examples of CS/OCC remapping used in Release-8 are shown in Tables 3A and 3B. An outcome of CS/OCC remapping is that partial orthogonality properties are lost. Majority of PUCCH Format 1/1a/1b resources denoted by grey color utilize OCC#2 during one of two slots.

TABLE 3A
Example of CS/OCC remapping, Slot #0

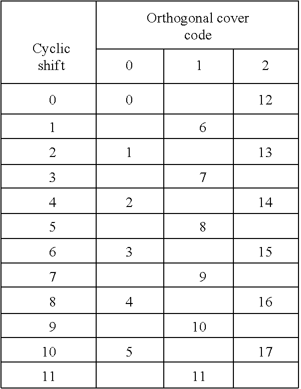

TABLE 3B
Example of CS/OSS remapping, Slot #1

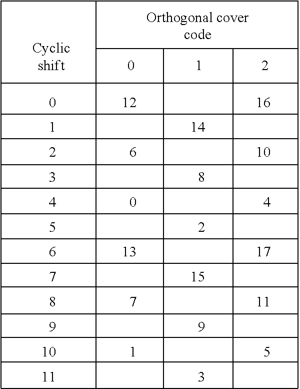

In an embodiment, there is provided a new High-Doppler configuration applicable to LTE with high-speed trains. In an embodiment, existing LTE configurations (normal CP, extended CP) are specifically combined in a way that maximizes the resistance against high mobility while minimizing the standardization and implementation efforts required.

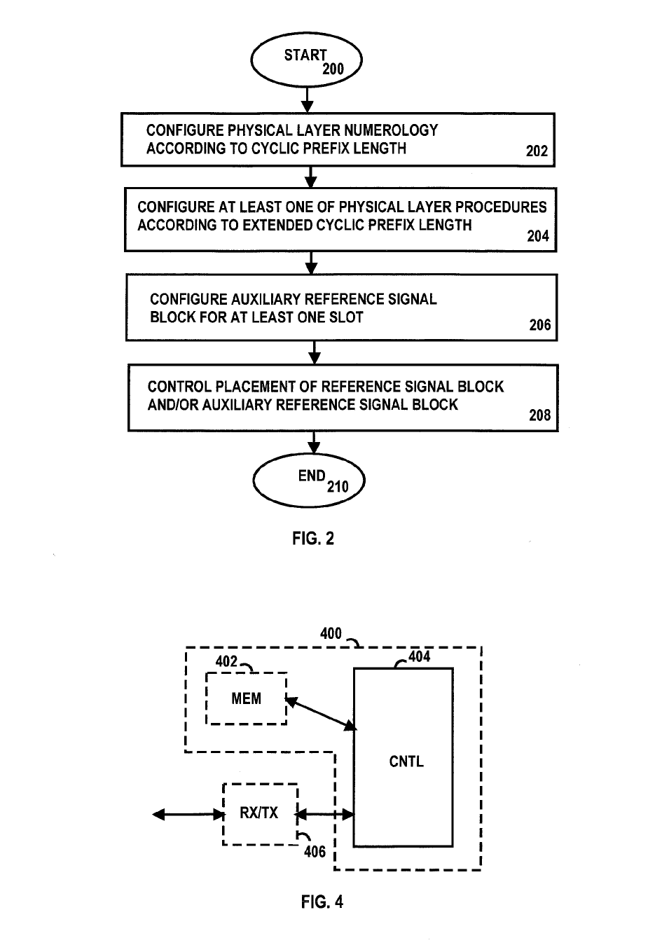

In the following, some embodiments of a method for enabling physical channel configuration are explained in further detail by means of FIG. 2. The steps/points, signaling messages and related functions described in FIG. 2 are in no absolute chronological order, and some of the steps/points may be performed simultaneously or in an order differing from the given one. Other functions can also be executed between the steps/points or within the steps/points and other signaling messages sent between the illustrated messages. Some of the steps/points or part of the steps/points can also be left out or replaced by a corresponding step/point or part of the step/point. Some of the steps/points can also be combined.

The method starts in block 200. In 202, physical layer numerology is configured according to a cyclic prefix length. In 204, at least one of physical layer procedures are configured according to an extended cyclic prefix length. In an embodiment, the cyclic prefix length is shorter than the extended cyclic prefix.

In 206, an auxiliary reference signal block is configured for at least one slot. In 208, the placement of at least one of: a reference signal block and the auxiliary reference signal block within a subframe is controlled.

An embodiment provides an apparatus which may be any node device, host, server or any other suitable apparatus able to carry out processes described above in relation to FIG. 2.

In an embodiment, in order to minimize the impact of required changes, the changes are encapsulated by using extended CP procedures, channelizations and/or multiplexing on top of slot format configured based on the normal CP length. FIG. 3 shows an embodiment applied to UL-SCH (Uplink Shared Channel). 301 shows that physical layer numerology is configured according to normal CP length. This configuration may define one or more of the following: total number of blocks per slot (e.g. up to 7) 310, 312, the absolute length of cyclic prefix for different SC-FDMA(/OFDMA) blocks, configuration of special subframe (TDD). In the embodiment of FIG. 3, there are 7 blocks (0, 1, 2, 3, 4, 5, 6) in Slot #0 310 and 7 blocks (7, 8, 9, 10, 11, 12, 14) in Slot #1 312.

302 shows that PHY procedures are configured according to extended CP length. This may define, for example, PUCCH channelization, PUCCH multiplexing in the case of (ACK/NACK+CQI), rate matching for uplink and downlink shared channel with the number output bits corresponding to extended CP (e.g. by means of N_{symb}^{PUSCH}) the placement of RI (rank indicator)/ACK/NACK symbols on physical uplink shared channel, PHICH resource allocation (DL), RS mapping (DL). In the embodiment of FIG. 3, a reference signal block 320, 321 is placed in each slot 310, 312. In 303, an auxiliary reference signal block 340, 341 per slot 310, 312 is configured. In an embodiment, there is an unused block per slot. In an embodiment, an existing DM RS block (base sequence, cyclic shift) is copied for the auxiliary reference signal block 340, 341. Proper randomization scheme may be applied for the auxiliary reference signal block 340, 341, e.g. cyclic shift hopping w.r.t., existing RS (reference signal) block(s).

In an embodiment, extending orthogonal cover code (OCC) to cover also the auxiliary RS block 340, 341 may be applied on PUCCH. In an embodiment, the auxiliary RS block 340, 341 per slot 310, 312 may also contain some data (DL). In an embodiment, the placement of at least one reference signal block is controlled based on optimizing at least one of the following: resisting interference due to high-speed scenario, different Relaying use case requirements, implementation requirements. In 304, the placement of at least one of: a resource signal block 320, 321 and an auxiliary reference signal block 340, 341 is optimized within the slot/sub-frame 310, 312. In an embodiment, the reference signal block 320, 321 and the auxiliary reference signal block 340, 341 placements are optimized for a high-speed case, i.e. the two RS blocks (RS block and auxiliary RS block) of the slot are located at both ends of the slot 310, 312. In an embodiment, different Relaying use cases may be used as a basis for optimizing the placement of the RS block, e.g. the last block may be missing. In another embodiment, specific implementation requirements may be used to determine the placement of the RS block.

In an embodiment, the configuration scheme may be applied for uplink only, for downlink only or for both uplink and downlink scenarios.

It is to be noted that the different steps described in context with FIG. 3 can also be carried out in different order than in the foregoing example. Further, some of the steps described may also be combined.

In an embodiment, broadcasted system information may be extended to cover also the High-Doppler configuration in addition to existing normal CP and extended CP length. For example, UL-CyclicPrefixLength is signaled as part of “RadioResourceConfigCommonSIB”. For example, in the current LTE specification, there are only two possible values for UL-CyclicPrefixLength: {len1, len2}, where len1 corresponds to normal cyclic prefix and len2 corresponds to extended cyclic prefix.

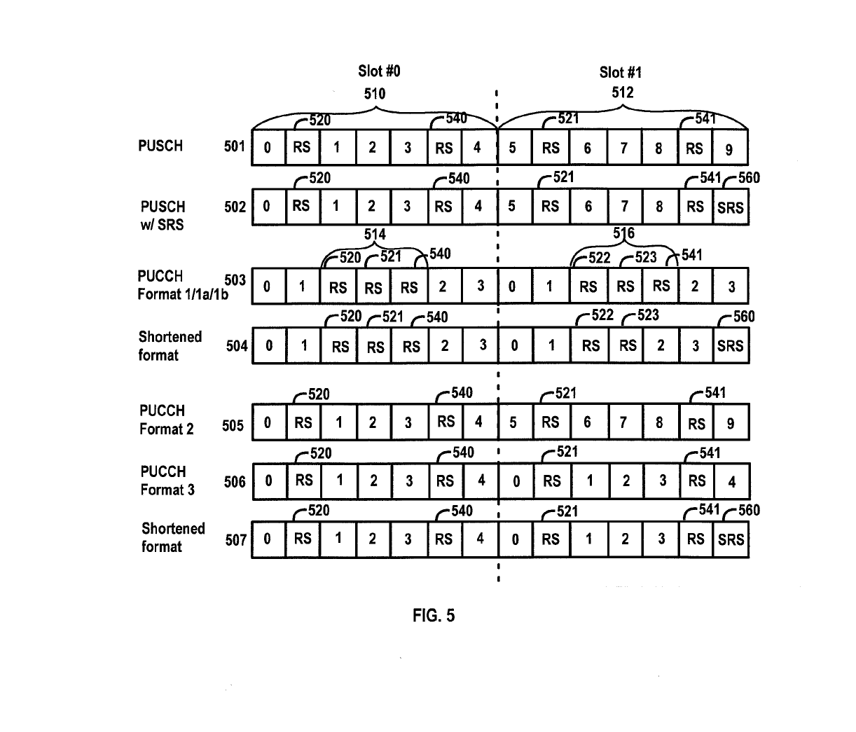

In an embodiment, the UE transmission and reception and eNB reception and transmission are defined for different uplink and downlink channels in view of the implementation of the embodiment. FIG. 5 shows examples 501-507 of modifying the UE transmission of different uplink channels such a way that the system becomes robust against high Doppler spread. FIG. 5 shows examples of proposed slot 510, 512 formats for different uplink channels applicable to different embodiments. PRACH (physical random access channel) should follow the existing configuration designed for normal CP length in this example. For simplicity, CP has been ignored from the FIG. 5.

In 501, in an example of a PUSCH arrangement, rate matching of the uplink shared channel is carried out with the number of output bits corresponding to the extended CP. In an embodiment, N_{symb}^{PUSCH} is counted according to the extended CP length. 501 shows exemplary symbol positions for ACK/NACK when multiplexed with PUSCH data. In 501, symbols for ACK/NACK are marked with: (1, 3, 6, 8) and symbols for rank information are marked with: (0, 2, 5, 7). Further, the exemplary placements of the reference signal blocks 520, 521 and the auxiliary reference signal blocks 540, 541 are illustrated. In 502, another example of a PUSCH arrangement with an SRS (sounding reference signal) block 560 is shown.

In 503, in an example of PUCCH Format 1/1a/1b arrangement, OCC is extended to cover also the auxiliary reference signal block 540, 541. This way the DM RS multiplexing scales automatically up in such a way that all UEs may capitalize the symbol energy of the auxiliary reference signal block. 514 and 516 show reference signal blocks 520, 521, 522, 523 and auxiliary reference signal blocks 540, 541 to which orthogonal cover codes are applied.

In an embodiment, the PUCCH Format 1/1a/1b channelization/OCC remapping is made according to the Extended CP. This is shown in Table 4. Channelization takes care that high-speed UEs under OCC #1 and #2 causing interference problems with high Doppler have been eliminated. Further, randomization takes care that favorable interference conditions are maintained during both slots. Table 4 shows an example of PUCCH Format 1/1a/1b channelization for cell-specific “High-Doppler configuration”. This example assumes that the delta_shift parameter equals to 2.

TABLE 4
PUCCH Format 1/1a/1b channelization for cell-
specific “High-Doppler configuration”

| | | |
|---|---|---|
| Cyclic | Orthogonal cover | Unused |

| shift | 0 | 1 | 2 | 3 |
|---|---|---|---|---|
| 0 | 0 | | | |
| 1 | | 6 | | |
| 2 | 1 | | | |
| 3 | | 7 | | |
| 4 | 2 | | | |
| 5 | | 8 | | |
| 6 | 3 | | | |
| 7 | | 9 | | |
| 8 | 4 | | | |
| 9 | | 10 | | |
| 10 | 5 | | | |
| 11 | | 11 | | |

In 504, a shortened format of a PUCCH arrangement with an SRS (sounding reference signal) block 560 is shown.

In 505, in an example of a PUCCH Format 2/2a/2b arrangement, PUCCH multiplexing in the case of (ACK/NACK+CQI) is based on joint coding of ACK/NACK and CQI instead of modulating the orthogonal cover code of DM RS signal (otherwise ACK/NACK detection would suffer from phase difference between DM RS symbols due to high Doppler).

506 shows an example of a PUCCH Format 3 arrangement and 507 illustrates an example of a shortened format with an SRS block 560.

In an embodiment, both high speed and normal UEs may be supported in the same cell due to the use of numerology of normal CP length. Basically, UEs can be configured either to normal and high speed mode, for example, with UE specific higher layer signaling. UEs configured to different modes may be separated with FDM, that is, by allocating them to different PRBs (physical resource blocks). In PUSCH scenario, this may be achieved with a simple scheduling restriction where MU-MIMO (multiuser multiple-input multiple-output) is not allowed between high speed and normal mode UEs. Additionally MU-MIMO may not be reasonable for high speed UEs. In PUCCH scenario, allocation to different PRBs is straightforward for semi-persistent PUCCH allocations. In an embodiment for a dynamic PUCCH ACK/NACK, a separate resource region is established. This can be achieved, for example, with a high speed mode specific resource offset used on top of existing dynamic ACK/NACK resource indication mechanism. In an embodiment, the offset may be configurable such that partial overlapping of normal mode and high speed mode dynamic ACK/NACK regions may be configured when desired.

Embodiments of the invention provide several advantages. For example, a single solution may provide high-Doppler solutions for all UL channels. The building blocks of existing systems may be reused maximally, that is, only small additional complexity is required. Implementation complexity and standardization effort may be minimized. Spectral efficiency can be kept at existing level, for example, Release-8 extended CP.

FIG. 4 illustrates a simplified block diagram of an apparatus according to an embodiment suitable for channel configuration. It should be appreciated that the apparatus may also include other units or parts than those depicted in FIG. 4. Although the apparatus has been depicted as one entity, different modules and memory (one or more) may be implemented in one or more physical or logical entities.

The apparatus 400 may in general include at least one processor, controller or a unit designed for carrying out control functions operably coupled to at least one memory unit and to various interfaces. Further, a memory unit may include volatile and/or non-volatile memory. The memory unit may store computer program code and/or operating systems, information, data, content or the like for the processor to perform operations according to embodiments. Each of the memory units may be a random access memory, hard drive, etc. The memory units may be at least partly removable and/or detachably operationally coupled to the apparatus.

The apparatus may be a software application, or a module, or a unit configured as arithmetic operation, or as a program (including an added or updated software routine), executed by an operation processor. Programs, also called program products or computer programs, including software routines, applets and macros, can be stored in any apparatus-readable data storage medium and they include program instructions to perform particular tasks. Computer programs may be coded by a programming language, which may be a high-level programming language, such as objective-C, C, C++, Java, etc., or a low-level programming language, such as a machine language, or an assembler.

Modifications and configurations required for implementing functionality of an embodiment may be performed as routines, which may be implemented as added or updated software routines, application circuits (ASIC) and/or programmable circuits. Further, software routines may be downloaded into an apparatus. The apparatus, such as a node device, or a corresponding component, element, unit, etc., may be configured as a computer or a microprocessor, such as a single-chip computer element, or as a chipset, including at least a memory for providing storage capacity used for arithmetic operation and an operation processor for executing the arithmetic operation.

As an example of an apparatus according to an embodiment, it is shown an apparatus, such as a node device or network element, including facilities in a control unit 404 (including one or more processors, for example) to carry out functions of embodiments according to FIG. 2. This is depicted in FIG. 4.

The apparatus may also include at least one processor 404 and at least one memory 402 including a computer program code, the at least one memory and the computer program code configured to, with the at least one processor, cause the apparatus at least to: configure physical layer numerology according to a cyclic prefix length; configure at least one of physical layer procedures according to an extended cyclic prefix length; configure an auxiliary reference signal block for at least one slot, and control the placement of at least one of: a reference signal block and the auxiliary reference signal block within a slot.

Another example of an apparatus comprises means 404 for configuring physical layer numerology according to a cyclic prefix length, means 404 for configuring at least one of physical layer procedures according to an extended cyclic prefix length, means 404 for configuring an auxiliary reference signal block for at least one slot, and means 404 for controlling the placement of at least one of: a reference signal block and the auxiliary reference signal block within a slot.

Yet another example of an apparatus comprises a configurer configured to configure physical layer numerology according to a cyclic prefix length, a configurer configured to configure at least one of physical layer procedures according to an extended cyclic prefix length, a configurer configured to configure an auxiliary reference signal block for at least one slot, and a controller configured to control the placement of at least one of: a reference signal block and the auxiliary reference signal block within a slot.

Embodiments of FIG. 2 may be carried out in a processor or control unit 404 possibly with aid of a memory 402 as well as a transmitter and/or receiver 406.

It should be appreciated that different units may be implemented as one module, unit, processor, etc, or as a combination of several modules, units, processor, etc. It should be understood that the apparatuses may include other units or modules etc. used in or for transmission. However, they are irrelevant to the embodiments and therefore they need not to be discussed in more detail herein. Transmitting may herein mean transmitting via antennas to a radio path, carrying out preparations for physical transmissions or transmission control depending on the implementation, etc. The apparatus may utilize a transmitter and/or receiver which are not included in the apparatus itself, such as a processor, but are available to it, being operably coupled to the apparatus. This is depicted as an option in FIG. 4 as a transceiver 406.

An embodiment provides a computer program embodied on a distribution medium, comprising program instructions which, when loaded into electronic apparatuses, constitute the apparatuses as explained above.

Another embodiment provides a computer program embodied on a computer readable medium, configured to control a processor to perform embodiments of the methods described above.

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, electrical carrier signal, telecommunications signal, and software distribution package, for example. Depending on the processing power needed, the computer program may be executed in a single electronic digital computer or it may be distributed amongst a number of computers.

The techniques described herein may be implemented by various means. For example, these techniques may be implemented in hardware (one or more devices), firmware (one or more devices), software (one or more modules), or combinations thereof. For a hardware implementation, the apparatus may be implemented within one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, other electronic units designed to perform the functions described herein, or a combination thereof. For firmware or software, the implementation can be carried out through modules of at least one chip set (e.g., procedures, functions, and so on) that perform the functions described herein. The software codes may be stored in a memory unit and executed by processors. The memory unit may be implemented within the processor or externally to the processor. In the latter case it can be communicatively coupled to the processor via various means, as is known in the art. Additionally, the components of systems described herein may be rearranged and/or complimented by additional components in order to facilitate achieving the various aspects, etc., described with regard thereto, and they are not limited to the precise configurations set forth in the given figures, as will be appreciated by one skilled in the art.

It will be obvious to a person skilled in the art that, as technology advances, the inventive concept can be implemented in various ways. The invention and its embodiments are not limited to the examples described above but may vary within the scope of the claims.

1. An apparatus comprising:
at least one processor and at least one memory including a computer program code, wherein the at least one memory and the computer program code are configured, with the at least one processor, to cause the apparatus at least to:
configure physical layer numerology according to a cyclic prefix length;
configure at least one of physical layer procedures according to an extended cyclic prefix length;
configure an auxiliary reference signal block for at least one slot, and
control the placement of at least one of: a reference signal block and the auxiliary reference signal block within a slot.

2. The apparatus of claim 1, wherein configuring the physical layer numerology according to the cyclic prefix is based on at least one of: defining the total number of blocks per slot, defining an absolute length of cyclic prefix for different blocks and defining configuration of a special subframe.

3. The apparatus of claim 1, wherein configuring the physical layer procedures is based on at least one of: defining physical uplink control channel channelization, defining physical uplink control channel multiplexing, rate matching for uplink and/or downlink shared channel with the number output bits corresponding to the extended cyclic prefix, placing rank indicator/positive acknowledgement/negative acknowledgement symbols on physical uplink shared channel, physical hybrid automatic repeat request indicator channel resource allocation and reference signal mapping.

4. The apparatus of claim 1, wherein configuring the auxiliary reference signal block for at least one slot is based on at least one of: copying existing demodulation reference signal block for the auxiliary reference signal block, applying a randomization scheme, extending orthogonal cover code to cover the auxiliary reference signal block and including data in the auxiliary reference signal block.

5. The apparatus of claim 1, wherein controlling the placement of at least one reference signal block is based on optimizing at least one of the following: resisting interference due to high-speed scenario, different Relaying use case requirements, implementation requirements.

6. The apparatus of claim 1, further configured to extend broadcasted system information to cover high-Doppler configuration in addition to existing normal cyclic prefix and extended cyclic prefix length.

7. The apparatus of claim 1, further configured to control configuring of one or more user equipment between a normal mode and a high speed mode with a user equipment specific higher layer signaling.

8. The apparatus of claim 1, further configured to apply rate matching uplink shared channel with the number of output bits corresponding to the extended cyclic prefix.

9. The apparatus of claim 1, further configured to extend orthogonal cover code to cover the auxiliary reference signal block.

10. The apparatus of claim 1, further configured to be applied for uplink only, for downlink only or for both uplink and downlink.

11. A computer program comprising instructions which, when loaded into the apparatus, constitute the modules of claim 1.

12. A method for physical channel configuration, characterized in that the method comprises:
configuring physical layer numerology according to a cyclic prefix length;
configuring at least one of physical layer procedures according to an extended cyclic prefix length;
configuring an auxiliary reference signal block for at least one slot, and
control the placement of at least one of: a reference signal block and the auxiliary reference signal block within a slot.

13. The method of claim 1, wherein configuring the physical layer numerology according to the cyclic prefix further comprises at least one of: defining the total number of blocks per slot, defining an absolute length of cyclic prefix for different blocks and defining configuration of a special subframe.

14. The method of claim 1, wherein configuring the physical layer procedures further comprises at least one of: defining physical uplink control channel channelization, defining physical uplink control channel multiplexing, rate matching for uplink and/or downlink shared channel with the number output bits corresponding to the extended cyclic prefix, placing rank indicator/positive acknowledgement/negative acknowledgement symbols on physical uplink shared channel, physical hybrid automatic repeat request indicator channel resource allocation and reference signal mapping.

15. The method of claim 1, wherein configuring the auxiliary reference signal block for at least one slot further comprises at least one of: copying existing demodulation reference signal block for the auxiliary reference signal block, applying a randomization scheme, extending orthogonal cover code to cover the auxiliary reference signal block and including data in the auxiliary reference signal block.

16. The method of claim 1, wherein controlling the placement of at least one reference signal block is based on optimizing at least one of the following: resisting interference due to high-speed scenario, different Relaying use case requirements, implementation requirements.

17. The method of claim 1, wherein optimizing the placement of at least one reference signal block further comprises placing the reference signal block and the auxiliary reference signal block at both ends of the subframe.

18. The method of claim 1, further comprising controlling configuring of one or more user equipment between a normal mode and a high speed mode with a user equipment specific higher layer signaling.

19. The method of claim 1, further comprising extending broadcasted system information to cover high-Doppler configuration in addition to existing normal cyclic prefix and extended cyclic prefix length.

20. The method of claim 1, further comprising rate matching uplink shared channel with the number of output bits corresponding to the extended cyclic prefix.

21. The method of claim 1, further comprising extending orthogonal cover code to cover the auxiliary reference signal block.

22. The method of claim 1, the method being applied for uplink only, for downlink only or for both uplink and downlink.

23. An apparatus comprising:
means for configuring physical layer numerology according to a cyclic prefix length;
means for configuring at least one of physical layer procedures according to an extended cyclic prefix length;
means for configuring an auxiliary reference signal block for at least one slot, and
means for controlling the placement of at least one of: a reference signal block and the auxiliary reference signal block within a slot.

24. A computer program embodied on a computer-readable storage medium, the computer program comprising program code for controlling a process to execute a process, the process comprising:
configuring physical layer numerology according to a cyclic prefix length;
configuring at least one of physical layer procedures according to an extended cyclic prefix length;
configuring an auxiliary reference signal block for at least one slot, and
controlling the placement of at least one of: a reference signal block and the auxiliary reference signal block within a slot.
